(19) United States
(12) Patent Application Publication
(10) Pub. No.: US 2004/0089502 A1
(43) Pub. Date: May 13, 2004

(54) Lift system with reduced power

(76) Inventor: Angelo Martini, Pero (IT)

Correspondence Address: ABELMAN, FRAYNE & SCHWAB, 26th Floor, 150 East 42nd Street, New York, NY, 10017-5612, US

(21) Appl. No.: 10/291,910

(22) Filed: Nov. 11, 2002

(51) Int. Cl. B66B 1/06

(52) U.S. Cl. 187/290

(57) ABSTRACT

A lift system with reduced power includes a car running inside a special lift-shaft, and at least a drive unit which allows the raising and the lowering of the car, with the drive unit having at least two power systems, and with the car including a sensor system to detect the load in the car in order to switch the drive unit of the lift system to one of the power systems.

### BACKGROUND OF THE INVENTION

1. Field of the Invention

The present invention relates to a lift system with reduced power. More particularly, the present invention relates to a lift system with reduced power which is particularly suitable for hydraulic and electric lift systems with or without a counterweight system.

2. Description of the Related Art

As it is known in the art, due to manufacturing rules, lift capacities depend on car sizes, as it supposed that the cars themselves can be completely filled up, particularly in an emergency. Car sizes comply with architectural concepts or local regulations, such as cars for handicapped and sick people transportation.

Accordingly, in known lift systems, a motor must be installed and its power must correspond to the maximum load; that is, the weight of the car itself plus the capacity of the lift system.

It is also known that a lift in operation is seldom used at full load. Therefore, for example, a lift used in European houses such as a four or five story block of flats generally has an eight person capacity, and is normally used by one, two, or at the most three persons.

Even a bedlift, for example, has a 1,000 kg. capacity, but the load in the car is generally in the range of 200 kg. to 300 kg. In other words, these lift systems are mostly used with loads that are greatly lower than the nominal load of the lift itself.

However, the power systems installed and the relevant connections must be provided for the maximum load of the lift, and therefore both initial installation costs and overhead costs incurred refer to the maximum load, even though the lift is normally used with lower loads.

It is easy to understand that, in these cases, in order to eliminate the above-mentioned drawbacks, the need for lift systems equipped with reduce power devices arises.

### BRIEF SUMMARY OF THE INVENTION

Therefore, the subject of the present invention is to provide a lift system with reduced power that, besides keeping the usual functionality, allows for the fixing of the above-mentioned drawbacks.

According to the present invention, these and other purposes resulting from the following description are achieved for providing a lift system with reduced power, with the lift system including a car running inside a special lift-shaft, and at least a drive unit which allows the raising and the lowering of the car, with the drive unit having at least two power systems, and with the car including a sensor system to detect the load in the car in order to switch the drive unit of the lift system to one of the power systems.

### DETAILED DESCRIPTION OF THE INVENTION

The manufacturing and operating features of the lift system with reduced power of the present invention will be better understood from the following description, wherein some preferred embodiments of the present invention are given by way of non-limiting examples.

The lift system subject of the present invention comprises a car for the transportation of loads, running inside a special lift-shaft, and a drive unit allowing the raising and lowering of the car.

The drive unit comprises a first power system and a second power system.

The first power system is sized for the normal or actual performance; that is, with a load being much lower than the maximum load allowed. In particular, a motor and a connection with a relevant energy meter of the first power system are sized for actual performance.

The second power system is sized according to current and/or specific provisions and regulations, and so the second power system is therefore able to securely raise and lower the car with the car having a full load capacity, but at a reduced speed compared to the speed of the car during the normal or actual performance actually carried out by the first power system.

The power installed or provided for the second power system is essentially equal to the power installed or provided for the first power system for normal or actual performance which is actually carried out.

The sensor system to detect the load inside the car detects the actual load and allows for the switching of the drive of the lift system to the first power system or to the second power system of the drive unit.

Even in the case of a hydraulic lift system without a counterweight, the nominal capacity is generally the same as the lift system weight; for, in the lift system with reduced power of the present invention, a first power system on the basis of the performance that is actually carried out can be sized together with a second power system complying with the current provisions on the basis of the power reduction carried out for the first power system.

With the lift system with reduced power of the present invention, a power savings is obtained, comprised of between about 35% and about 45% of the power that is installed and used in prior art lift systems.

For example, in the case of a bedlift, the first power system is sized for a car load ranging from about 200 kg. to about 300 kg., while the second power system is sized in order to raise and lower the car at a lower speed at the nominal capacity of about 1,000 kg. plus the dead weight of the car.

In this case, the power savings is comprised of between about 40% and about 45% in comparison to lift systems of the prior art, with a subsequent speed decrease of the present invention comprised between about 40% and about 45% of speeds of lift systems of the prior art.

Even in the case of a hydraulic lift system or an electric lift system with a counterweight, with the lift system with reduced power of the present invention, the utmost advantage can be obtained by counterweighting the lift system with about 30% of the nominal capacity, thus allowing a power reduction of about 40% compared to the power used by a lift system of the prior art with the same features.

The lift system with reduced power of the present invention allows for the installation of power systems which are about 40% to about 45% lower than power systems installed in a lift system of the prior art, with a reduction of installation costs and overhead during performance. For example, with a lift system of the present invention used in houses, a savings comprised between about 30% and about 40% is obtained compared to a lift system of the prior art both in terms of non-recurring payment at the installation of the lift system, and also in terms of fixed and yearly amounts which are proportional to the installed power.

As it can be understood from the previous description, the lift system of the present invention is easy to manufacture and install. Moreover, it is highly functional and versatile, thus allowing the present invention to reach into diverse facilities, such as houses and hospitals, and allowing the elimination of the reported drawbacks with reference to the prior art.

In order to meet specific requirements, a technician skilled in the art will be able to make many changes and variants, or a combination of variants to the above-described lift system with reduced power of the present invention, such as the use of multi-speed motors, of Variable Voltage Variable Frequency (VVVF) systems, or the use of two pumps instead of one pump used in known lift systems, or the use of two motors instead of one motor of a given drive unit, or the use of power systems which are partly or completely independent but suitable to carry out a speed reduction when the load conditions of the car exceed a predefined value, or other suitable systems can be used.

It is therefore clear that the present invention is meant to include all of the changes and variants falling within the spirit and the scope and field of the protection of the following claims.

What is claimed is:

1. A lift system with reduced power comprising:
a car running inside a special lift-shaft; and
at least one drive unit which raises and lowers the car, with the at least one drive unit having:
at least two power systems; and
wherein the car includes:
a sensor system to detect the load in the car in order to switch the at least one drive unit to one of the at least two power systems.

2. The lift system with reduced power according to claim 1, wherein the drive unit includes:
a first power system; and
a second power system.

3. The lift system with reduced power according to claim 2, wherein the first power system is sized for raising and lowering the car at normal load capacity.

4. The lift system with reduced power according to claim 2, wherein the second power system is sized for raising and lowering the car at full load capacity at a reduced speed than the speed of the car at normal load capacity, with the installed power of the second power system operating at full load capacity being substantially equal to the installed power of the first power system operating at normal load capacity.

5. The lift system with reduced power according to claim 2, wherein the sensor system for the detection of the car load switches the at least one drive unit to one of the first power system or the second power system.

6. The lift system with reduced power according to claim 1, wherein the at least one driver unit includes:
multi-speed motors.

7. The lift system with reduced power according to claim 1, further comprising:
Variable Voltage Variable Frequency (VVVF) systems

8. The lift system with reduced power according to claim 1, wherein the lift system is a hydraulic lift system without a counterweight.

9. The lift system with reduced power according to claim 1, wherein the lift system is an electric lift system.

10. The lift system with reduced power according to claim 9, wherein the electric lift system includes a counterweight.

11. The lift system with reduced power according to claim 9, wherein the electric lift system lacks a counterweight.
